(19) United States
(12) Patent Application Publication
(10) Pub. No.: US 2003/0081891 A1
(43) Pub. Date: May 1, 2003

(54) Chromatic dispersion control using index variation

(76) Inventors: Vitor M. Schneider, Painted Post, NY (US); Kevin W. Bennett, Hammondsport, NY (US)

Correspondence Address: Volentine Francos, P.L.L.C., Suite 150, 12200 Sunrise Valley Drive, Reston, VA, 20191, US

(21) Appl. No.: 09/983,770

(22) Filed: Oct. 25, 2001

(51) Int. Cl. G02B 6/26; G02B 6/16

(52) U.S. Cl. 385/27; 385/123

(57) ABSTRACT

According to an exemplary embodiment of the present invention, a chromatic dispersion control apparatus includes an optical waveguide, and a device which dynamically alters an index of refraction of the optical waveguide to adjust the chromatic dispersion in an optical signal traversing the optical waveguide.

According to another exemplary embodiment of the present invention, a chromatic dispersion control method includes controllably varying a temperature of an optical waveguide to adjust the chromatic dispersion present in an optical signal traversing the optical waveguide.

### CROSS-REFERENCE TO RELATED APPLICATIONS

The present invention is related to U.S. Patent Application Serial Number (Atty. Docket Number CRNG.027), entitled “Chromatic Dispersion Control Method and Apparatus,” filed on even date herewith; and U.S. Patent Application Serial Number (Atty. Docket Number CRNG.020), entitled “Dynamic Chromatic Dispersion Control Using Coupled Optical Waveguides” filed on even date herewith. The above referenced inventions are assigned to the assignee of the present invention. The disclosures of these referenced patent applications are specifically incorporated by reference herein and for all purposes.

### FIELD OF THE INVENTION

The present invention relates generally to optical communications, and particularly to a method and apparatus for dynamically controlling chromatic dispersion in optical communications systems.

### BACKGROUND OF THE INVENTION

Optical transmission systems, including optical fiber communication systems, have become an attractive alternative for carrying voice and data at high speeds. In optical transmission systems, waveform degradation due to chromatic dispersion (CD) in the optical transmission medium can be problematic, particularly as transmission speeds continue to increase.

Chromatic dispersion results from the fact that in transmission media such as glass optical waveguides, the higher the frequency of the optical signal, the greater is the refractive index. As such, higher frequency components of optical signals will “slow down,” and contrastingly, lower frequency signals will “speed-up.” In single mode optical fiber, chromatic dispersion results from the interplay of two underlying effects, material dispersion and waveguide dispersion. Material dispersion results from the nonlinear dependence upon wavelength of the refractive index, and the corresponding group velocity of the material, illustratively doped silica. Waveguide dispersion results from the wavelength dependent relationships of the group velocity to the core diameter and the difference in the index of refraction between the core and the cladding.

In addition to the above sources of CD, impurities in the waveguide material, mechanical stress and strain, and temperature effects can also affect the index of refraction, further adding to the ill-effects of chromatic dispersion.

In digital optical communications, where the optical signal is ideally a square wave, bit-spreading due to chromatic dispersion can be particularly problematic. To this end, as the “fast frequencies” in the signal slow down and the “slow frequencies” in the signal speed up as a result of chromatic dispersion, the shape of the waveform can be substantially impacted. The effects of this type of dispersion are a spreading of the original pulse in time, causing it to overflow into the time slot that has already been allotted to another bit. When the overflow becomes excessive, intersymbol interference (ISI) may result. ISI may result in an increase in the bit-error rate to unacceptable levels.

As can be appreciated, control of the total chromatic dispersion of transmission paths in an optical communication system is critical to the design and construction of long-haul, and high-speed communications systems. To achieve this, it is necessary to reduce the total dispersion to a point where its contribution to the bit-error rate of the signal is acceptable. In commonly used dense wavelength division multiplexed (DWDM) optical communications systems, there may be 40 wavelength channels or more, having channel center wavelength spaced approximately 0.8 nm to approximately 1.0 nm apart. Illustratively, a 40-channel system could have center wavelengths in the range of approximately 1530 nm to approximately 1570 nm. As can be appreciated, controlling for chromatic dispersion in such a system, and in a dynamic manner, can be difficult.

Accordingly, what is needed is a method and apparatus for dynamically compensating for chromatic dispersion in optical fiber communications systems.

### SUMMARY OF THE INVENTION

According to an exemplary embodiment of the present invention, a chromatic dispersion control apparatus includes an optical waveguide, and a device which dynamically alters an index of refraction of the optical waveguide to adjust the chromatic dispersion compensation to an optical signal traversing the optical waveguide.

According to another exemplary embodiment of the present invention, a chromatic dispersion control method includes controllably varying a temperature of an optical waveguide to vary the chromatic dispersion compensation to an optical signal traversing the optical waveguide.

### BRIEF DESCRIPTION OF THE DRAWINGS

The invention is best understood from the following detailed description when read with the accompanying drawing figures. It is emphasized that the various features are not necessarily drawn to scale. In fact, the dimensions may be arbitrarily increased or decreased for clarity of discussion.

FIG. 1 is a functional block diagram of a chromatic dispersion compensation module in accordance with an exemplary embodiment of the present invention.

FIG. 2 is a graphical representation of total dispersion variation versus wavelength for an optical fiber at various test temperatures.

FIG. 3 is a graphical representation of the total dispersion variation with temperature for different dispersion compensating fibers coils having a relatively small radius of curvature.

FIG. 4 is a graphical representation of the total dispersion variation with temperature for different dispersion compensating fibers having a relatively large radius of curvature.

FIG. 5 is a functional block diagram of a dispersion compensation module in accordance with another exemplary embodiment of the present invention.

FIG. 6 is a functional block diagram of a chromatic dispersion compensation module in accordance with another exemplary embodiment of the present invention.

### DETAILED DESCRIPTION

In the following detailed description, for purposes of explanation and not limitation, exemplary embodiments disclosing specific details are set forth in order to provide a thorough understanding of the present invention. However, it will be apparent to one having ordinary skill in the art having had the benefit of the present disclosure, that the present invention may be practiced in other embodiments that depart from the specific details disclosed herein. Moreover, descriptions of well-known devices, methods and materials may be omitted so as to not obscure the description of the present invention.

Briefly, the present invention relates to a method and apparatus for controlling chromatic dispersion in an optical signal and over a relatively wide wavelength band. In accordance with an exemplary embodiment, a dispersion control module includes a coiled fiber and a temperature source which alters the temperature of the coiled fiber to selectively adjust the chromatic dispersion present in an optical signal traversing the coiled fiber. According to another exemplary embodiment of the present invention, a dispersion control method includes controllably varying a temperature of a coiled fiber to selectively adjust chromatic dispersion present in an optical signal traversing the coiled optical fiber.

As is described in further detail herein, the dispersion control apparatus and method in accordance with an exemplary embodiment of the present invention incorporates an optical waveguide (e.g. optical fiber) which is specially designed for dispersion compensation. Illustratively, the dispersion control apparatus and method provide chromatic dispersion correction that is approximately equal in value to the chromatic dispersion present in an optical signal but, of course, having opposite sign so the net chromatic dispersion is zero. To wit, if the dispersion in the optical signal is positive, the dispersion control apparatus and method usefully provide a negative dispersion of equal magnitude to approximately cancel the overall affect of the dispersion in the optical signal. However, it is noted that there may be instances where it is desired to have the net chromatic dispersion in an optical signal be non-zero. In accordance with an exemplary embodiment, the chromatic dispersion present in an optical may be selectively adjusted to a desired positive or negative value.

As a result of the dispersion control method and apparatus in accordance with an exemplary embodiment of the present invention, chromatic dispersion may be dynamically controlled in optical communications systems having transmission rates on the order of approximately 10 Gbit and greater. Moreover, this dispersion control may be affected over a relatively broad wavelength band, illustratively including wavelengths in the range of approximately 1530 nm to approximately 1570 nm. Finally, in a manner which will become more clear as the description proceeds, in addition to controlling chromatic dispersion in an optical signal, the method and apparatus in accordance with exemplary embodiments of the present invention enable control of the dispersion slope of an optical signal across a prescribed wavelength band.

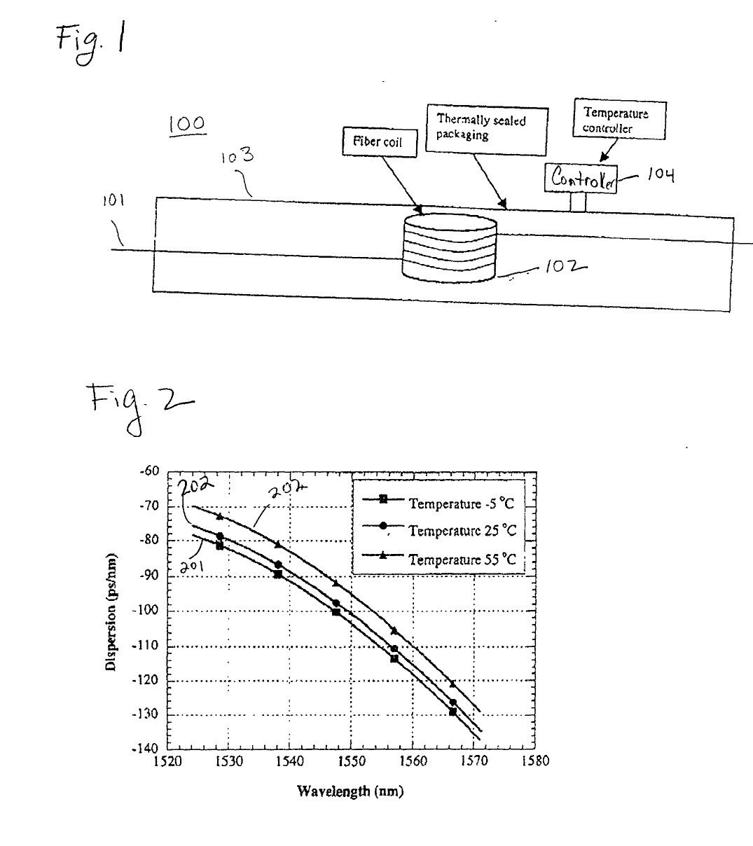

Turning to FIG. 1, a dispersion control module 100 in accordance with an exemplary embodiment of the present invention is shown. An input optical fiber 101 is optically coupled to a fiber coil 102. The fiber coil 102 is disposed in a thermally sealed package 103. A controller 104 may be used to effect a change in the temperature of the fiber coil 102. This variation in temperature enables a change in the index of refraction profile of the fiber of fiber coil 102, which ultimately enables dynamic control of chromatic dispersion and dispersion slope in an optical signal traversing the fiber.

The temperature control of the fiber coil 102 may be achieved via an open loop control scheme without feedback of the system performance (e.g. a temperature is set and maintained at a constant level). Alternatively, the temperature control of the fiber coil 102 may be achieved via a closed-loop control scheme which dynamically adjusts the temperature of the coil based on system performance feedback. For example, the closed-loop control scheme could be based upon a measured bit-error rate (BER) of the system. The temperature of the coil could be varied over a certain range (e.g. approximately −40° C. to approximately 100° C.) to control the bit-error rate. Of course, the BER of the system is but one measure of system performance. Other measures of performance could be used in the illustrative closed-loop control scheme.

It is noted while the above description of control schemes is directed primarily to control of the temperature of the fiber coil in either an open loop or a closed loop scheme, other techniques may be used to effect refractive index changes to dynamically control CD and dispersion slope in an optical signal in accordance with exemplary embodiments of the present invention. For example, controller 104 may be used to vary the index of refraction of fiber coil 102 by varying the radius of curvature of the fiber of fiber coil 102 and/or the tension on the fiber of the fiber coil 102.

In one illustrative embodiment where the controller 104 controls the stress forces on the fiber coil 102 and the radius of curvature of the fiber coil 102, the fiber coil 102 may be disposed about a cylindrical (e.g. a mandrel) or other suitably shaped element, which may be controllably rotated via the controller 104. Alternatively, the fiber coil 102 may be statically disposed, and the controller 104 would only change the temperature of the coil.

Finally, as will become more clear as the description proceeds, the control of the index of refraction may be achieved using one of the above exemplary techniques, or by using a combination thereof. Regardless, the adjustment of CD present in an optical signal may be achieved in a closed-loop control scheme or an open-loop control scheme.

The optical fiber, which is wound to comprise the fiber coil 102, is particularly designed for dispersion compensation in accordance with exemplary embodiments of the present invention. As is known, at typical telecommunication and data communication wavelengths of operation, conventional dispersion compensation fibers are specifically designed to operate in a region where waveguide dispersion is greater in magnitude than material dispersion. Typically, this is in the region of approximately 1.55 μm, as the material dispersion of the silica based optical fiber usually crosses zero dispersion level and turns positive at approximately 1.33 μm.

Non-zero dispersion shifted fibers operate with almost zero dispersion values, and are designed by changing the waveguide parameters and shifting the waveguide dispersion and consequently the overall chromatic dispersion, which includes the waveguide and material dispersion, to values near zero at approximately 1.55 μm. The result in many cases is a dispersion compensating fiber that has almost zero dispersion values in the operational wavelength, but which usually presents a positive dispersion curve slope.

As the bit rates of optical communications systems exceed 10 Gbit/sec, it is useful to control both for the absolute dispersion value and for the dispersion slope to guarantee low bit-error rate transmission across the chosen wavelength band. This is particularly the case in multi-channel wavelength division multiplexing (WDM) and (DWDM) optical systems.

The optical fiber which is used in the fiber coil 102 in accordance with exemplary embodiments of the present invention is designed to aid in the compensation of both the slope and dispersion at all wavelengths of operation. The optical fibers used in fiber coil 102 illustratively have a relatively small core diameter and a relatively high refractive index difference between the core and the cladding layer when compared to conventional single mode fibers such as SMF-28.

Further examples of optical fiber which can be used in the fiber coil 102 are the subject of U.S. Pat. Nos. U.S. 5,361,319, and 5,999,679, both to Antos, et al. The disclosures of these patents are specifically incorporated by reference herein; and these patents are assigned to the assignee of the present invention. Of course, these are merely illustrative of the optical waveguides which may be used in accordance with an exemplary embodiment of the present invention. It is noted that other optical waveguides, including other types of dispersion compensating waveguides, may be used in keeping with the exemplary embodiments of the present invention and the desirable characteristics of the optical waveguides as described herein.

The above referenced characteristics of the optical fiber (or other optical waveguide) result in the chromatic dispersion characteristics of the fiber being particularly sensitive to index of refraction changes. For example, the chromatic dispersion in the optical fiber of fiber coil 102 is particularly sensitive to changes in the temperature of the fiber. Moreover, as will become more clear as the description proceeds, the radius of curvature of the optical fiber as well as the tension/stress placed upon the optical fiber can also impact the degree of dispersion compensation versus wavelength for particular optical fibers used in accordance with an exemplary embodiment of the present invention. Illustratively, chromatic dispersion adjustment in an optical signal in the range of approximately −400 ps/nm to approximately+400 ps/nm may be achieved in accordance with an exemplary embodiment of the present invention.

Turning to FIG. 2, the dispersion versus wavelength is shown for an illustrative optical fiber at various temperatures in keeping with an exemplary embodiment of the present invention. As can be seen, when the optical fiber is at a temperature of −5° C., the dispersion curve 201 exhibits a particular dispersion profile versus wavelength. At a temperature of +25° C., the same fiber has a different slope 203, which has a downward profile versus wavelength. At this temperature, the fiber has slightly lower levels of chromatic dispersion for a particular wavelength. Finally, as can be seen, the same optical fiber at a temperature of 55° C. exhibits decreasing chromatic dispersion with wavelength, but with less magnitude at each given wavelength than the previous two temperatures.

As can be appreciated from a review of FIG. 2, the variation of the chromatic dispersion versus wavelength as a result of changes in the temperature can be used to selectively control the degree of chromatic dispersion compensation in an optical signal. In the illustratively embodiment shown in FIG. 1, the optical fiber in accordance with the exemplary embodiments of the present invention may be disposed in the fiber coil 102 and suitably heated or cooled to change the degree of dispersion over the particular wavelength band. In the dispersion compensation module 100, this would be affected by controlling a temperature source (not shown) with the controller 104.

It is noted that in the exemplary embodiment shown in FIG. 1, as well as other exemplary embodiments described herein, the optical fiber is disposed in a coiled manner. While this is illustrative of the embodiments of the present invention, it is not necessary. To wit, the fiber may be coiled as shown in the exemplary embodiments of FIGS. 1, 5 and 6. Alternatively, the fiber may be completely uncoiled, and just suitably heated/cooled to effect dispersion compensation in an optical signal. Finally, as described above, optical waveguides other than optical fibers may be used in keeping with the exemplary embodiments of the present invention. These waveguides also may or may not be coiled. The index of refraction, and thus the dispersion characteristics of these optical waveguides may be selectively dynamically altered by the techniques as described herein.

As referenced previously, the behavior of the optical waveguide used for chromatic dispersion compensation in accordance with exemplary embodiments of the present invention may be tightly or loosely coiled. To this end, the radius of curvature of the illustrative optical fiber may be relatively small or relatively large, depending upon application. Moreover, it may be useful to introduce stress on the fiber in order to alter the index of refraction, and ultimately the degree of chromatic dispersion. This may be done, for example, by disposing the fiber coil about a mandrel which may be rotated to increase or decrease the tension on the fiber, as is desired. In accordance with the exemplary embodiment shown in FIG. 1, the controller 104 may be used to rotate a servo motor which is connected to a mandrel about which the fiber coil 102 is disposed.

It is noted that many combinations of radii or curvature of the fiber and tension applied to the fiber are available in keeping with the present invention. According to an illustrative embodiment, the radius of curvature of the fiber is maintained in the range of approximately 2.0 inches to approximately 6.0 inches. The tension applied to the fiber is illustratively in the range of approximately 0.0 Newtons to approximately 0.2 Newtons. It is emphasized that the dispersion compensation in accordance with exemplary embodiments of the present invention may be effected through the variety of techniques described taken individually or in combination. For example, the use of temperature alteration is merely exemplary, and could be used alone, in combination with other techniques, or foregone in lieu of other techniques used alone or in combination with one another.

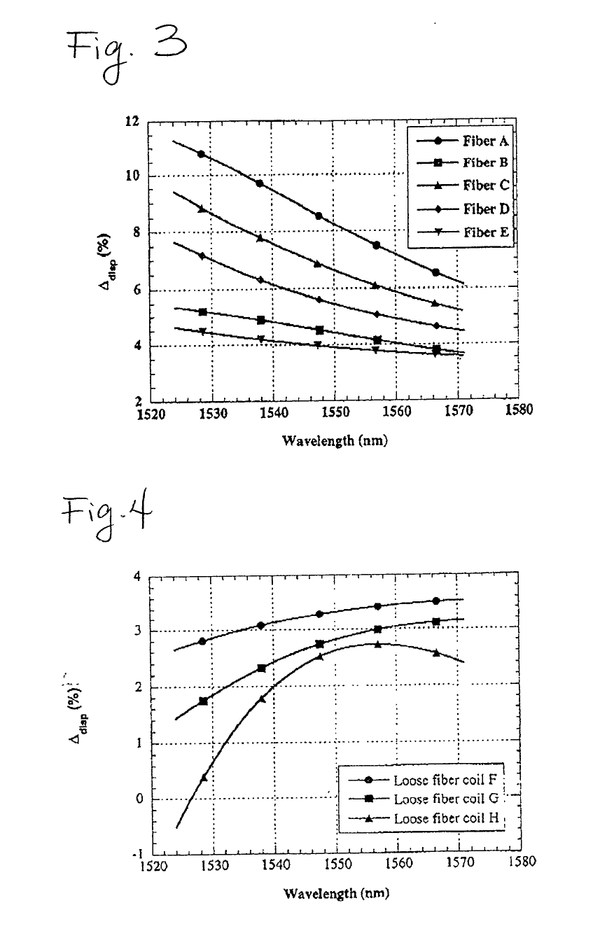

As described, a variety of techniques for altering the index of refraction to introduce dispersion compensation may be used. Again, these may be effected individually or in combination with one another and/or with temperature variation. Turning to FIG. 3, the change in dispersion versus wavelength is shown for five different dispersion compensating fibers maintained when the temperature is changed from −5° C. to +55° C. in accordance with an exemplary embodiment of the present invention. The dispersion compensating fibers of the exemplary embodiment shown in FIG. 3 have a relatively low radius of curvature. In this illustrative embodiment, the relatively small radius of curvature is accompanied by a relatively high tension/stress placed on the fiber. For a particular temperature, the different optical fibers shown in FIG. 3 exhibit a different degree of dispersion over wavelength. As can be appreciated, over the particular wavelength band shown, the various fibers in accordance with an exemplary embodiment of the present invention exhibit dispersion variation ranging from approximately 4% to approximately 12%. The degree of dispersion variation depends upon the particular fiber used and its thermal sensitivity in terms of waveguide design. It is also noted that the general trend for the relatively tightly wound fiber coils of the illustrative embodiment of FIG. 3 is a decrease in the dispersion variation with increasing wavelength.

Turning to FIG. 4, the total dispersion variation versus wavelength for three different optical fibers having the same relatively large radius of curvature is shown. In this example, the tension/stress applied to the fiber is relatively low. Again, the temperature is changed in the range of −5° C. to +55° C. for each optical fiber shown graphically in FIG. 4. As can be appreciated from a review of FIG. 4, the various optical fibers at the particular temperature have significantly different dispersion variations over wavelength. However, as can be appreciated, the total dispersion variation generally increases with increasing wavelengths.

From the above description, it can be appreciated that changes in the temperature, the radius of curvature of the coiled optical fiber, and the tension/stress imposed thereon, alone or in combination enable a wide range of chromatic dispersion compensation over a relatively broad wavelength band. Moreover, it is noted once again that other optical waveguides may be used, and that it is not always necessary to coil the fibers.

According to an exemplary embodiment of the present invention, one or more coils of fiber may be deployed in a dispersion compensation module such as dispersion compensation module 100. For example, it may be useful to have a fiber which has a relatively low radius of curvature in one coil and another fiber which has a relatively high radius of curvature in another coil. Ultimately, a variety of dispersion compensation values and slopes may be realized with such a dispersion compensation module. As before, if desired, the temperature of the optical fibers of the dispersion compensation module 100 may be varied and controlled using controller 104 to effect a desired amount of chromatic dispersion compensation in an optical signal traversing optical fiber 101. Moreover, the tension on the individual fiber coils as well as their radii of curvature may be dynamically controlled in a manner described previously.

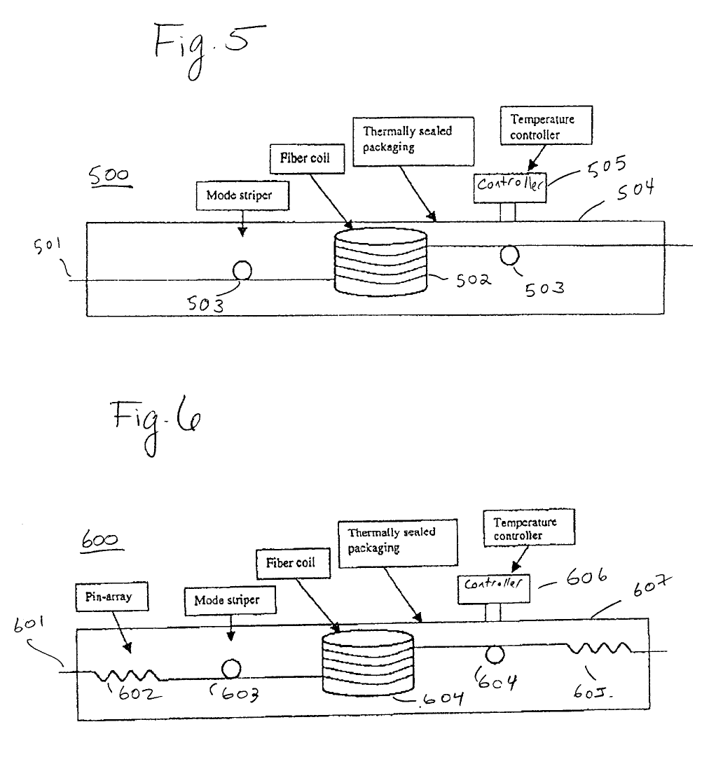

Turning to FIG. 5, a dispersion compensation module 500 in accordance with another exemplary embodiment of the present invention is shown. The dispersion compensation module 500 includes substantially all of the elements of the dispersion compensation module 100 of FIG. 1, with some noteworthy additions. Accordingly, the details of the similar elements and their characteristics will be omitted in the interest of brevity, and only distinctions therebetween will be described in detail.

Dispersion compensation module 500 in accordance with the exemplary embodiment of the present invention includes an input optical fiber 501 and a fiber coil 502. A controller 505 usefully controls the temperature of the fiber coil and/or tension or stress on the fiber coil as well as its radius of curvature. The optical fiber 501 used in fiber coil 502, the controller 505, and the dynamic control of dispersion compensation are as previously described. In accordance with the exemplary embodiment shown in FIG. 5, mode strippers 503 are usefully employed. These mode strippers 503 would be disposed in the thermally sealed package 504. The mode strippers 503 illustratively include optical fibers or other suitable optical waveguides disposed about a mandrel. The optical fiber/waveguide typically exhibit the same dispersion characteristics as those of optical fiber 501. The mandrel typically has a radius of curvature which is substantially smaller than the radius of curvature of fiber coil 502. The mode strippers can be used to induce micro-bending in the optical fiber disposed thereabout. Ultimately, this can improve the dispersion variation, especially in the case where the optical fiber supports multiple modes. It is noted that the mode strippers 503 may also be dynamically controlled by controller 505. To this end, the radius of curvature of the fibers used in the mode strippers 503 may be altered to effect a desired degree of dispersion variation.

Turning to FIG. 6, a dispersion compensation module 600 in accordance with another exemplary embodiment of the present invention is shown. An input optical fiber 601 is coupled to a first pin array 602. The first pin array 602 is coupled to a first mode stripper 603, which is coupled to fiber coil 604. Output from the fiber coil 604 is input to a second mode stripper 604, which is coupled to a second pin array 605. All of these elements are disposed in a thermally sealed package 607. A controller 606 may be used to control the temperature, the radius of curvature, and the tension on various elements of the dispersion compensation module 600. As can be appreciated, many of the elements shown in FIG. 6 are substantially the same and carry out substantially the same function as those common elements of the exemplary embodiment shown in FIG. 5. Accordingly, repetition of these details has been omitted, and only distinctions described in detail.

First and second pin arrays 602 and 605, respectively, are particularly useful in introducing micro-bends in the optical fiber. These micro-bends in the optical fiber may be used to improve dispersion variation, particularly in the case of optical fibers which support multiple modes. The first pin arrays 602 arrays are merely illustrative, and other elements could also be used to induce micro-bends in the optical fiber to improve the dispersion variation.

It is also noted that the micro bending of the fiber may be dynamically controlled and varied through the use of controller 606 as well as suitable mechanisms for variation of the micro-bends. The micro-bend can be effected in a variety of ways. Examples include the use of an array of pins of various sizes and spacing therebetween. Moreover, a mandrel that is adapted to expand/contract may be used. Alternatively, a mesh of metallic wire may be used to selectively exert pressure on the fiber. Still other techniques are possible for inducing microbends, as would be readily apparent to one having ordinary skill in the art.

The invention having been described in detail in connection through a discussion of exemplary embodiments, it is clear that modifications of the invention will be apparent to one having ordinary skill in the art having had the benefit of the present disclosure. Such modifications and variations are included in the scope of the appended claims.

We claim:

1. A chromatic dispersion control apparatus, comprising:
an optical waveguide; and
a device which dynamically alters an index of refraction of said optical waveguide to adjust the chromatic dispersion in an optical signal traversing said optical waveguide.

2. A chromatic dispersion control apparatus as recited in claim 1, wherein said device dynamically alters said index of refraction by controlling a parameter chosen from the group consisting essentially of: a temperature of said waveguide, a radius of curvature of said waveguide and a tension applied to said waveguide.

3. A chromatic dispersion control apparatus as recited in claim 1, wherein said device dynamically alters a temperature of said optical waveguide.

4. A chromatic dispersion control apparatus as recited in claim 1, wherein said device dynamically alters a radius of curvature of said optical waveguide.

5. A chromatic dispersion control apparatus as recited in claim 1, wherein said device dynamically alters a tension applied to said optical waveguide.

6. A chromatic dispersion control apparatus as recited in claim 1, wherein said optical waveguide is an optical fiber.

7. A chromatic dispersion control apparatus as recited in claim 6, wherein said optical fiber is a dispersion compensating optical fiber.

8. A chromatic dispersion control apparatus as recited in claim 6, wherein said optical fiber has a relatively high refractive index difference between a core layer and a cladding layer.

9. A chromatic dispersion control apparatus as recited in claim 1, wherein said waveguide is coiled.

10. A chromatic dispersion control apparatus as recited in claim 9, wherein said coiled optical waveguide is disposed about a mandrel.

11. A chromatic dispersion control apparatus as recited in claim 9, wherein said coiled optical waveguide has a controlled variable tension applied thereto.

12. A chromatic dispersion control apparatus as recited in claim 1 1, wherein said coiled optical waveguide has a variable radius of curvature.

13. A chromatic dispersion control apparatus as recited in claim 1, wherein a controller is operatively coupled to said device.

14. A chromatic dispersion control apparatus as recited in claim 13, wherein said controller is part of an open-loop control scheme.

15. A chromatic dispersion control apparatus as recited in claim 13, wherein said controller is part of a closed-loop control scheme.

16. A chromatic dispersion control apparatus as recited in claim 1, further comprising at least one mode stripper.

17. A chromatic dispersion control apparatus as recited in claim 1, further comprising a device which selectively introduces micro-bends to an optical fiber.

18. A chromatic dispersion control apparatus as recited in claim 1, wherein the apparatus is disposed in a thermally sealed module.

19. A chromatic dispersion control apparatus as recited in claim 3, wherein said temperature of said waveguide is in the range of approximately −40° C. to approximately +100° C.

20. A chromatic dispersion control apparatus as recited in claim 1, wherein said adjustment of chromatic dispersion in said optical signal is in the range of approximately −400 ps/nm to approximately +400 ps/nm and said optical signal has a wavelength in the range of approximately 1520 nm to approximately 1570 nm.

21. A chromatic dispersion control apparatus as recited in claim 1, wherein said adjustment in chromatic dispersion in said optical signal is in the range of approximately 4% to approximately 12% over a wavelength range of said optical signal of approximately 1520 nm to approximately 1570 nm.

22. A chromatic dispersion control apparatus as recited in claim 1, wherein said adjustment in chromatic dispersion in said optical signal is in the range of approximately −1% to approximately 4% over a wavelength range of said optical signal of approximately 1520 nm to approximately 1570 nm.

23. A chromatic dispersion control method, comprising:
controllably varying an index of refraction of an optical waveguide to adjust chromatic dispersion present in an optical signal traversing said optical waveguide.

24. A chromatic dispersion control method as recited in claim 23, wherein said varying of said index of refraction further comprises varying a parameter chosen from the group consisting essentially of a temperature of said optical waveguide, a radius of curvature of said optical waveguide, and a tension applied to said optical waveguide.

25. A chromatic dispersion control method as recited in claim 23, wherein said varying of said index of refraction further comprises dynamically varying a temperature of said optical waveguide.

26. A chromatic dispersion control method as recited in claim 23, wherein said varying of said index of refraction further comprises dynamically varying a radius of curvature of said optical waveguide.

27. A chromatic dispersion control method as recited in claim 23, wherein said varying of said index of refraction further comprises dynamically varying a tension applied to said optical waveguide.

28. A chromatic dispersion control method as recited in claim 25, wherein said temperature is varied in the range of approximately −40° C. to approximately +100° C.

29. A chromatic dispersion control method as recited in claim 23, wherein said optical waveguide is an optical fiber.

30. A chromatic dispersion control method as recited in claim 29, wherein said optical fiber is coiled.

31. A chromatic dispersion control method as recited in claim 30, wherein said coiled optical fiber is disposed about a mandrel.

32. A chromatic dispersion control method as recited in claim 31, wherein a tension is variably applied by rotation of said mandrel.

33. A chromatic dispersion control method as recited in claim 30, wherein said coiled fiber has a variable radius of curvature.

34. A chromatic dispersion control method as recited in claim 23, wherein said adjustment in dispersion in said optical signal is in the range of approximately −400 ps/nm to approximately +400 ps/nm and said optical signal has a wavelength in the range of approximately 1520 nm to approximately 1570 nm.

35. A chromatic dispersion control method as recited in claim 23, wherein said adjustment in chromatic dispersion is in the range of approximately 4% to approximately 12% over a wavelength range of said optical signal of approximately 1520 nm to approximately 1570 nm.

36. A chromatic dispersion control method as recited in claim 23, wherein adjustment in chromatic dispersion is in the range of approximately −1% to approximately 4% over a wavelength range of said optical signal of approximately 1520 nm to approximately 1570 nm.

37. A chromatic dispersion control method as recited in claim 32, wherein said tension is in the range of approximately 0.0 N to approximately 0.2 N.

38. A chromatic dispersion control method as recited in claim 33, wherein said variable radius of curvature is in the range of approximately 2 inches to approximately 6 inches.
